(19) United States
(12) Patent Application Publication
(10) Pub. No.: US 2010/0099827 A1
(43) Pub. Date: Apr. 22, 2010

(54) POLYMERIZABLE MONOMER COMPOSITION AND METHOD FOR PREVENTING POLYMERIZATION

(75) Inventors: Norihito Nishimura, Aizuwakamatsu-shi (JP); Katsutoshi Ohno, Aizuwakamatsu-shi (JP); Tetsuhiro Furukawa, Aizuwakamatsu-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku, Tokyo (JP)

(21) Appl. No.: 12/516,991

(22) PCT Filed: Nov. 29, 2007
(86) PCT No.: PCT/JP2007/073532

§ 371 Date: May 29, 2009

(30) Foreign Application Priority Data
Dec. 1, 2006 (JP) 2006-325832

(51) Int. Cl. C08L 33/00

(52) U.S. Cl. 525/375

(57) ABSTRACT

The present invention provides a method for preventing polymerization, and a polymerizable monomer composition favorably used therefor that includes a (meth)acryloyl group-containing isocyanate compound and a specific polymerization inhibitor.

The polymerizable monomer composition includes a (meth)acryloyl group-containing isocyanate compound and a stable free radical compound. The invention effectively prevents the polymerization of the (meth)acryloyl group-containing isocyanate compound and the occurrence of polymers due to the polymerization. Furthermore, the use of a stable free radical compound which has a vapor pressure approximate to that of the (meth)acryloyl group-containing isocyanate compound can effectively prevent polymerization in a vapor phase and a condensation phase of distillation facility.

### TECHNICAL FIELD

The present invention relates to a polymerizable monomer composition comprising a (meth)acryloyl group-containing isocyanate compound and a stable free radical compound, and a method for preventing polymerization of a (meth)acryloyl group-containing isocyanate compound.

### BACKGROUND ART

(Meth)acryloyl group-containing compounds tend to be polymerized very easily by heat, light, and other factors and are often polymerized during production and purification to produce polymers, causing breakdown of production facilities. If this polymer adheres to production tanks, distillation columns, and pipes used in the manufacturing and purification processes of the (meth)acryloyl group-containing compounds, it not only causes clogging and sticking of movable equipment but also interferes with production and purification of the (meth)acryloyl group-containing compounds. Also, removing the polymer which has adhered to related facilities entails man power, which is inefficient. As a result, the facilities must be shut down for a long time, causing a significant economic loss. Further, the polymer may cause bad product quality.

There have been then proposed or practically employed many polymerization inhibitors and methods of preventing polymerization, in order to control the generation of polymer in the production facilities of (meth)acryloyl group-containing compounds.

In general, hydroquinone and methoxyhydroquinone have been used as the polymerization inhibitors for (meth)acryloyl group-containing compounds. They, however, do not show satisfactory effects. In place of these inhibitors, the utilization of phenothiazine, BHT (2,6-di-tert-butyl-4-methylphenol) and the like has been proposed. However, satisfactory effects of preventing polymerization have not yet been realized.

In particular, the prevention of polymerization is more difficult in the vapor phase and condensation phase as in distillation and the like, compared to polymerization prevention in the liquid phase wherein a polymerization inhibitor can be added directly and the concentration thereof can be controlled. In droplets formed by condensation of vapor in the distillation column, heat exchanger, and the like, there is not enough polymerization inhibitor dissolved when compared to the liquid phase (for example, distillation still liquid), and thus polymerization is easy to occur. In order to solve this problem, there have been proposed a method wherein a polymerization inhibitor is dissolved in an organic solvent, distillate or the like, and is fed to the reflux line (see Patent Document 1), and a method wherein the concentration of oxygen is controlled (see Patent Document 2). These methods improve the situation to some degree but have such drawbacks as a difficulty in controlling the polymerization inhibitor concentration, and occasional occurrence of polymers and their attachment to the production facilities. Thus, the advent has been strongly desired of better polymerization inhibitors and more effective methods of preventing polymerization for (meth)acryloyl group-containing compounds.

Among the (meth)acryloyl group-containing compounds, (meth)acryloyl group-containing isocyanate compounds have an isocyanate group with high reactivity towards compounds with an active hydrogen atom such as those with hydroxyl groups or primary or secondary amino groups, and also have a carbon-carbon double bond which can undergo vinyl polymerization. Thus, the (meth)acryloyl group-containing isocyanate compounds are extremely useful in the industry, and are used as polyfunctional monomers in a variety of applications such as paints and coatings, adhesives, photo-resists, dental materials, magnetic recording materials, and the like. These compounds, due to the presence of a plurality of highly reactive functional groups in the molecule, are more susceptible to polymerization during the manufacturing process. It is also expected that the reactivity of the isocyanate group itself may lead to easier generation of polymers. Therefore, higher-level measure to prevent polymerization is necessary.

Patent Document 1: Japanese Patent Laid-Open Publication No. 2003-103155

Patent Document 2: Japanese Patent Laid-Open Publication No. H9-67311

### DISCLOSURE OF THE INVENTION

### Problems to be Solved by the Invention

The present invention has an object of providing a method for preventing polymerization and also providing a polymerizable monomer composition suitably used therefor that comprises a (meth)acryloyl group-containing isocyanate compound and a specific polymerization inhibitor.

### Means for Solving the Problems

The present inventors have studied the polymerization characteristics of a (meth)acryloyl group-containing isocyanate compound in detail, and as a result, have discovered that a stable free radical compound effectively prevents the polymerization of the (meth)acryloyl group-containing isocyanate compound. This discovery has led to completion of the present invention. Namely, the present invention includes the following aspects.
[1] A polymerizable monomer composition comprising a (meth)acryloyl group-containing isocyanate compound and a stable free radical compound.
[2] The polymerizable monomer composition described in [1], wherein the stable free radical compound is represented by the following general formula (1):

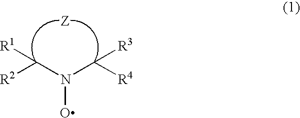

wherein R¹, R², R³, and R⁴ are each independently a hydrogen atom, a linear or branched alkyl group which is substituted or unsubstituted, or a substituted or unsubstituted aryl group, at least one of R¹ and R² is a linear or branched alkyl group which is substituted or unsubstituted, or a substituted or unsubstituted aryl group, and at least one of R³ and R⁴ is a linear or branched alkyl group which is substituted or unsubstituted, or a substituted or unsubstituted aryl group;

R¹ and R² may be bonded to each other to form a cyclic structure;

R³ and R⁴ may be bonded to each other to form a cyclic structure; and

Z is an alkylene group having 2 to 5 carbon atoms or a bivalent aromatic group, wherein the alkylene group or the aromatic group may further have a substituent.
[3] The polymerizable monomer composition described in [2], wherein Z is a substituted or unsubstituted alkylene group having 2 or 3 carbon atoms.
[4] The polymerizable monomer composition described in any one of [1] to [3], wherein the stable free radical compound is at least one compound selected from 2,2,6,6-tetramethylpiperidine-N-oxyl and 4-hydroxy-2,2-6,6-tetramethylpiperidine-N-oxyl.
[5] The polymerizable monomer composition described in any one of [1] to [4], wherein the stable free radical compound is contained in an amount of 1 mass ppm to 10 mass % relative to the (meth)acryloyl group-containing isocyanate compound.
[6] The polymerizable monomer composition described in any one of [1] to [5], wherein the (meth)acryloyl group-containing isocyanate compound is at least one compound selected from 2-methacryloyloxyethyl isocyanate, 4-methacryloyloxybutyl isocyanate, 5-methacryloyloxypentyl isocyanate, 6-methacryloyloxyhexyl isocyanate, 2-acryloyloxyethyl isocyanate, 3-methacryloyloxyphenyl isocyanate, and 1,1-bis(acryloyloxymethyl)ethyl isocyanate.
[7] A method for preventing polymerization of a (meth)acryloyl group-containing isocyanate compound, wherein a stable free radical compound is used as a polymerization inhibitor for the (meth)acryloyl group-containing isocyanate compound.
[8] The method for preventing polymerization of a (meth)acryloyl group-containing isocyanate compound described in [7], wherein the stable free radical compound is represented by the following general formula (1):

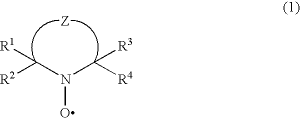

wherein R¹, R², R³, and R⁴ are each independently a hydrogen atom, a linear or branched alkyl group which is substituted or unsubstituted, or a substituted or unsubstituted aryl group, at least one of R¹ and R² is a linear or branched alkyl group which is substituted or unsubstituted, or a substituted or unsubstituted aryl group, and at least one of R³ and R⁴ is a linear or branched alkyl group which is substituted or unsubstituted, or a substituted or unsubstituted aryl group;

R¹ and R² may be bonded to each other to form a cyclic structure;

R³ and R⁴ may be bonded to each other to form a cyclic structure; and

Z is an alkylene group having 2 to 5 carbon atoms or a bivalent aromatic group, wherein the alkylene group or the aromatic group may further have a substituent.
[9] The method for preventing polymerization of a (meth)acryloyl group-containing isocyanate compound described in [7] or [8], wherein Z is a substituted or unsubstituted alkylene group having 2 or 3 carbon atoms.
[10] The method for preventing polymerization of a (meth)acryloyl group-containing isocyanate compound described in any one of [7] to [9], wherein a vapor pressure of the stable free radical compound is 0.2 to 5 times that of the (meth)acryloyl group-containing isocyanate compound.
[11] The method for preventing polymerization of a (meth)acryloyl group-containing isocyanate compound described in any one of [7] to [10], wherein the stable free radical compound is at least one compound selected from 2,2,6,6-tetramethylpiperidine-N-oxyl and 4-hydroxy-2,2,6,6-tetramethylpiperidine-N-oxyl.
[12] The method for preventing polymerization of a (meth)acryloyl group-containing isocyanate compound described in any one of [7] to [11], wherein the stable free radical compound is used in an amount of 1 mass ppm to 10 mass % relative to the (meth)acryloyl group-containing isocyanate compound.
[13] The method for preventing polymerization of a (meth)acryloyl group-containing isocyanate compound described in any one of [7] to [12], wherein the (meth)acryloyl group-containing isocyanate compound is at least one compound selected from 2-methacryloyloxyethyl isocyanate, 4-methacryloyloxybutyl isocyanate, 5-methacryloyloxypentyl isocyanate, 6-methacryloyloxyhexyl isocyanate, 2-acryloyloxyethyl isocyanate, 3-methacryloyloxyphenyl isocyanate, and 1,1-bis(acryloyloxymethyl)ethyl isocyanate.
[14] The method for preventing polymerization of a (meth)acryloyl group-containing isocyanate compound described in any one of [7] to [13], wherein at least one selected from phenolic polymerization inhibitors, sulfur polymerization inhibitors, and phosphorus polymerization inhibitors is used together as a polymerization inhibitor.
[15] A polymer composition comprising a (co)polymer with structural units derived from a (meth)acryloyl group-containing isocyanate compound, and a stable free radical compound.
[16] A method for manufacturing a polymer composition, comprising polymerizing the polymerizable monomer composition described in [1].

### Effect of the Invention

The polymerizable monomer compositions according to the present invention comprise a (meth)acryloyl group-containing isocyanate compound and a stable free radical compound. The invention effectively prevents polymerization of the (meth)acryloyl group-containing isocyanate compound and prevents generation of polymers due to the polymerization.

According to an embodiment of the invention, the stable free radical compound has a vapor pressure approximate to that of the (meth)acryloyl group-containing isocyanate compound. According to this embodiment, the polymerization is effectively prevented in the distillation process in the vapor phase, condensation phase and the like of the distillation facility.

### BRIEF DESCRIPTION OF THE DRAWINGS

FIG. 1 shows vapor pressure curves measured using a thermogravimeter (TG).

FIG. 2 shows plots of the logarithm of polymerization initiation time when the polymerization inhibitors listed in Table 1 are added.

### BEST MODE FOR CARRYING OUT THE INVENTION

The present invention relates to a polymerizable monomer composition comprising a (meth)acryloyl group-containing isocyanate compound and a stable free radical compound, and also to a method for preventing polymerization. In the invention, the stable free radical compound prevents the polymerization of the (meth)acryloyl group-containing isocyanate compound during manufacturing and purification of the (meth)acryloyl group-containing isocyanate compound. The invention also effectively prevents the generation of polymers due to the polymerization.

It is noted that, in the specification, “(meth)acryloyl” refers to acryloyl or methacryloyl wherein the hydrogen atoms may be partly substituted. Also, “(meth)acryloyl group-containing isocyanate compound” means a composition which substantially comprises a (meth)acryloyl group-containing isocyanate compound and which may contain small amounts of acidic gas and hydrolyzable chlorine, except when it is specifically mentioned that the “(meth)acryloyl group-containing isocyanate compound” is a single compound.

In the following, the present invention will be described in more detail.

### [Polymerizable Monomer Composition]

### <Stable Free Radical Compound>

In the present invention, a stable free radical compound is used as a polymerization inhibitor. Here, the stable free radical compound means a compound which can be isolated in a state of radical at room temperature. Examples of the stable free radical compounds for the polymerizable monomer composition of the present invention include:

nitroxide free radicals such as PROXYL (2,2,5,5-tetramethyl-1-pyrrolidine-N-oxyl), 3-carboxy-PROXYL, 3-carbamoyl-PROXYL, 2,2-dimetyl-4,5-cyclohexyl-PROXYL, 3-oxo-PROXYL, 3-hydroxylimine-PROXYL, 3-aminomethyl-PROXYL, 3-methoxy-PROXYL, 3-tert-butyl-PROXYL, 3-maleimido-PROXYL, 3,4-di-tert-butyl-PROXYL, 3-carboxylic-2,2,5,5-tetramethyl-1-pyrrolidinine-N-oxyl, TEMPO (2,2,6,6-tetramethyl-1-piperidine-N-oxyl), 4-benzoxyloxy-TEMPO, 4-methoxy-TEMPO, 4-carboxylic-4-amino-TEMPO, 4-chloro-TEMPO, 4-hydroxylimine-TEMPO, 4-hydroxy-TEMPO, 4-oxo-TEMPO, 4-oxo-TEMPO-ethyleneketal, 4-amino-TEMPO, 2,2,6,6-tetraetyl-1-piperidine-N-oxyl, 2,2,6-trimethyl-6-ethyl-1-piperidine-N-oxyl, and derivatives thereof;

dialkyl nitroxide radicals such as di-tert-butyl nitroxide, diphenyl nitroxide, tert-butyl-tert-amyl nitroxide, DOXYL (4,4-dimethyl-1-oxazolidine-N-oxyl), 2-di-tert-butyl-DOXYL, 5-decyl-DOXYL, 2-cyclohexyl-DOXYL, and derivatives thereof;

2,5-dimethyl-3,4-dicarboxylic-pyrrole, 2,5-dimethyl-3,4-diethylester-pyrrole, 2,3,4,5-tetraphenyl-pyrrole, 3-cyano-pyrroline, 3-carbamoyl-pyrroline, 3-carboxylic-pyrroline, and the like;

1,1,3,3-tetramethylisoindoline-2-yloxyl, 1,1,3,3-tetraethylisoindoline-2-yloxyl, and the like;

porphyrexide nitroxyl radicals such as 5-cyclohexylporphirexide nitroxyl;

2,2,4,5,5-pentamethyl-A3-imidazoline-3-oxido-1-oxyl and the like;

galvinoxyl and the like;

1,3,3-trimethyl-2-azabicyclo[2,2,2]octane-5-one-2-oxide, 1-azabicyclo[3,3,1]nonane-2-oxide, and the like; and

DPPH (1,1-diphenyl-2-picrylhydrazyl).

Further, compounds represented by the general formulae (2) and (3) may also be used.

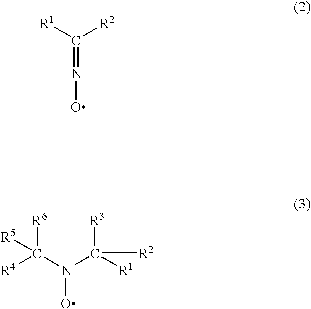

In the formula, R¹, R², R³, R⁴, R⁵, and R⁶ may be the same or different and represent atoms such as chlorine, bromine and iodine; saturated or unsaturated, and linear, branched or cyclic hydrocarbon groups such as alkyl or phenyl groups; ester groups or alkoxy groups; phosphoric acid ester groups; and polymer chains such as polymethyl methacrylate chain, polybutadiene chain, polyethylene chain, polypropylene chain and polystyrene chain, preferably polystyrene chain.

Preferable examples of the stable free radical compounds include those represented by the formula (1). In particular, TEMPO and 4-hydroxy-TEMPO are preferable from the standpoint of industrial availability.

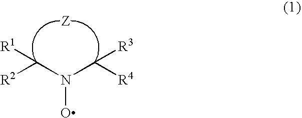

(In the formula, R¹, R², R³, and R⁴ are each independently a hydrogen atom, a linear or branched alkyl group which is substituted or unsubstituted, or a substituted or unsubstituted aryl group, at least one of R¹ and R² is a linear or branched alkyl group which is substituted or unsubstituted, or a substituted or unsubstituted aryl group, and at least one of R³ and R⁴ is a linear or branched alkyl group which is substituted or unsubstituted, or a substituted or unsubstituted aryl group;

R¹ and R² may be bonded to each other to form a cyclic structure;

R³ and R⁴ may be bonded to each other to form a cyclic structure;

Z is an alkylene group having 2 to 5 carbon atoms or a bivalent aromatic group, wherein the alkylene group or the aromatic group may further have a substituent.)

Alternatively to the stable free radical compound itself, a precursor of the stable free radical compound may be added to generate the free radical in the system. Examples of the stable free radical precursors include ordinary HALS (hindered amine-type light stabilizer) compounds. Specific examples include SANOL LS Series products (produced by Sankyo Life Tech Co., Ltd., trademark), and TINUVIN Series products (produced by Ciba Specialty Chemicals Inc., trademark).

The amount of the stable free radical compound relative to the (meth)acryloyl group-containing isocyanate compound varies depending on the composition of the polymerizable monomer composition and is appropriately determined depending on the production step to which the composition is subjected. When the content of impurities is high or when the composition is heated, the polymerization is more likely and thus the amount of the polymerization inhibitor has to be increased. In processes such as reaction process where the content of impurities is high and the reaction mixture is heated at a high temperature, the amount of the stable free radical compound added is in the range of 0.01 mass % to 10 mass %, preferably 0.1 mass % to 5 mass % based on the mass of the (meth)acryloyl group-containing isocyanate compound. On the other hand, in the case in which the content of impurities is low such as in the distillation process, the amount of the stable radical compound added is in the range of 1 mass ppm to 5 mass %, preferably 20 mass ppm to 1 mass %, based on the mass of the (meth)acryloyl group-containing isocyanate compound. When the amount of the stable free radical compound added is large, the economic efficiency drops. When the amount is too small, a sufficient effect of polymerization inhibition is not obtained.

There is no restriction on how and when the stable free radical compound is added. It may be added to the (meth)acryloyl group-containing isocyanate compound or to a solution thereof. Alternatively, a solution of the stable free radical compound prepared beforehand may be added. For example, at the distillation process in the production of (meth)acryloyl group-containing isocyanate compound, the stable free radical compound may be fed as a solution in the feed or reflux liquid, because the stable free radical compound dissolves relatively easily in the organic solvents used in the production of the (meth)acryloyl group-containing isocyanate compound.

### <(Meth)Acryloyl Group-Containing Isocyanate Compound>

There is no particular restriction on the (meth)acryloyl group-containing isocyanate compound which is a constituent of the polymerizable monomer composition of the present invention, as long as it is obtained by the usual manufacturing method of (meth)acryloyl group-containing isocyanate compound.

Examples of the compounds include 2-methacryloyloxyethyl isocyanate, 3-methacryloyloxy-n-propyl isocyanate, 2-methacryloyloxyisopropyl isocyanate, 4-methacryloyloxy-n-butyl isocyanate 2-methacryloyloxy-tert-butyl isocyanate, 2-methacryloyloxybutyl 4-isocynate, 2-methacryloyloxybutyl 3-isocynate, 2-methacryloyloxybutyl 2-isocyanate, 2-methacryloyloxybutyl 1-isocyanate, 5-methacryloyloxy-n-pentyl isocyanate, 6-methacryloyloxy-n-hexyl isocyanate, 7-methacryloyloxy-n-heptyl isocyanate, 3-methacryloyloxypheny isocyanate, 4-methacryloyloxyphenyl isocyanate, 2-acryloyloxyethyl isocyanate, 3-acryloyloxy-n-propyl isocyanate, 2-acryloyloxyisopropyl isocyanate, 4-acryloyloxy-n-butyl isocyanate, 2-acryloyloxy-tert-butyl isocyanate, 2-acryloyloxybutyl 4-isocyanate, 2-acryloyloxybutyl 3-isocyanate, 2-acryloyloxybutyl 2-isocyanate, 2-acryloyloxybutyl 1-isocyanate, 5-acryloyloxy-n-pentyl isocyanate, 6-acryloyloxy-n-hexyl isocyanate, 7-acryloyloxy-n-heptyl isocyanate, 3-acryloyloxyphenyl isocyanate, 4-methacryloyloxyphenyl isocyanate, 4-acryloyloxyophenyl isocyanate, 1,1-bis(methacryloyloxymethyl)methyl isocyanate, 1,1-bis(methacryloyloxymethyl)ethyl isocyanate, 1,1-bis(acryloyloxymethyl)methyl isocyanate, 1,1-bis(acryloyloxymethyl)ethyl isocyanate, and the like.

There may also be mentioned derivatives of these compounds in which hydrogen atoms of the alkyl groups are substituted by fluorine. Among these, preferable are 2-methacryloyloxyethyl isocyanate, 4-methacryloyloxy-n-butyl isocyanate, 5-methacryloyloxy-n-pentyl isocyanate, 6-methacryloyloxy-n-hexyl isocyanate, 2-acryloyloxyethyl isocyanate, 3-methacryloyloxyphenyl isocyanate, 4-methacryloyloxyphenyl isocyanate, and 1,1-bis(methacryloyloxymethyl)ethyl isocyanate.

### <Other Components>

In the manufacturing process of the aforementioned (meth)acryloyl group-containing isocyanate compounds, polymers such as low-fluidity or solid-like polymers are generated. When impurities formed in the process react with the (meth)acryloyl group of the (meth)acryloyl group-containing isocyanate compound, oligomers and polymers which are gels or popcorn polymers are formed. When the reaction takes place between the isocyanate group of the (meth)acryloyl group-containing isocyanate compound and the impurity, biuret, isocyanurate or compounds with a urethane or urea bond are formed. When these polymers adhere to or flow into the pipes, heat exchangers, and pumps of the production facilities, troubles such as impediment of flow of the process liquid and obstruction of operation of the rotating machines occur, making it difficult to control the production and distillation processes.

### [Method for Preventing Polymerization]

### <Evaluation of the Method for Preventing Polymerization>

Evaluation of the method for preventing polymerization can be performed by general methods. In particular, from the standpoint of polymer generation which is a problem in the operation of the production facilities, the following evaluation methods may be used:
(A) The polymerization inhibitor is added to the process liquid or product, and the mixture is held at a constant temperature. The time until polymer nucleation is measured.
(B) The polymerization inhibitor is added to the process liquid or product, and the mixture is subjected to operations (distillation, condensation, stirring, and the like) similar to those in the practical production process. The time until polymer nucleation is measured.

The polymer nucleation may be detected visually or by detecting the temperature rise due to the heat of polymerization.

### <Vapor Pressure of the Polymerization Inhibitor>

As the polymerization inhibitor, the stable free radical compound preferably has a vapor pressure approximate to that of the (meth)acryloyl group-containing isocyanate compound at a distillation temperature. When the stable free radical compound has a vapor pressure approximate to that of the (meth)acryloyl group-containing isocyanate compound, it not only prevents the polymerization in the still but also prevents effectively the polymerization at the vapor phase of the distillation apparatus because the stable free radical compound intermixes with the polymerizable monomer fraction which condenses at the vapor phase of the distillation apparatus. The vapor pressure of the stable free radical is in the range of 0.2 to 5 times, preferably 0.3 to 3 times that of the (meth)acryloyl group-containing isocyanate compound, at a liquid temperature in the still in the distillation process.

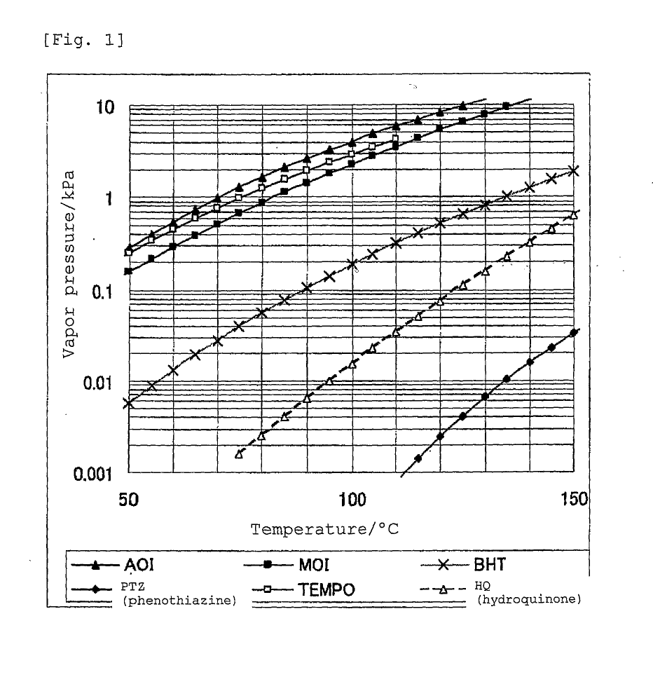

The vapor pressure can be measured by general methods, for example, a static method using a Bourdon gauge or a transpiration method. FIG. 1 shows vapor pressure curves measured by a method which uses a thermogravimeter (TG) described in the Proceedings of the 64th Autumn Meeting of the Japan Society of Applied Physics, 2003, 1p-ZA-1.

The vapor pressure may be measured with TG as follows. A sample is placed thin and flat on a bottom of a container. The vapor from the sample is allowed to diffuse upward in the container only by molecular diffusion without being affected by a carrier gas which flows to satisfy interfacial conditions such that the vapor concentration is zero at the upper end of the container. The vapor pressure is determined based on the Fick's diffusion equation. The evaporation speed measured with TG, diffusion coefficient D calculated by putting a molecular volume at a boiling point into Gilliland's equation, temperature T, amount of evaporation N, and height H from the sample surface to the upper end of the container are substituted into the Fick's diffusion equation to obtain a solution as the vapor pressure. The vapor pressure is measured at various temperatures and vapor pressure curves of samples may be obtained.

When 2-acryloyloxyethyl isocyanate (AOI) is distilled under reduced pressure while the liquid inside the still has a temperature of 90° C., it is preferable to select TEMPO which has a vapor pressure approximate to that of AOI. Phenothiazine, BHT and the like have a lower vapor pressure than that of AOI and are less volatile. Hence, they are not effective as polymerization inhibitors for condensates at the vapor phase of the distillation apparatus.

### <Polymer Composition and Manufacturing Method Thereof>

The polymerizable monomer composition of the present invention may be polymerized or cured by conventional methods. The methods for polymerizing and copolymerizing via the (meth)acryloyl groups include application of energy beams such as ultraviolet light and electron beams, and addition of polymerization initiators. Alternatively, the isocyanate groups may be reacted with active proton compounds (alcohol or amine) to form urethane or urea bonds respectively, or the isocyanate groups may be reacted with each other to form isocyanurate or biuret compounds. Because of the stable free radical, the stability of the cured product is not reduced and the cured product can be used as usual.

### Examples

Hereafter, the present invention will be further detailed with Examples. However, the present invention is not limited by these Examples.

<Measurement Conditions>Measurement of Vapor Pressure with TG

To an aluminum container (diameter 5 mm×height 5 mm), 33.240 mg of 2-methacryloyloxyethyl isocyanate (MOI) was added. The whole was introduced to a TG apparatus (TG/DTA 6200 manufactured by Seiko Instruments Inc.). Nitrogen gas was flowed at 350 mL/min, and the sample furnace was heated at a rate of 10° C/min from room temperature to 90° C. and was held at 90° C. for 5min. The average DTG (change in TG) during the five minutes was 229 mg/min and the sample temperature was 91.5° C.

Because the surface area of the sample=the bottom area of the container=0.196 (cm²), and the molecular weight of MOI=155.15 (g/mol),

the evaporation rate N_{A}=229÷60,000,000÷0.196÷155.15=1.255×10⁻⁷ (mol/cm²·s).

The following values were substituted into the Fick's diffusion equation: the molecular volume at boiling point: 182.66 (cm³/mol); the depth of the container (since the sample thickness was 0.1 cm) H=0.4 cm; the gas constant R=82.06 (cm³·atm/(mol·K)); the diffusion coefficient D from Gilliland's equation=0.0789 (cm²/s); and the total pressure P₀=1 (atm).

Consequently, the vapor pressure P=N_{A}HRT/DP₀=1554 (Pa).

### Example 1-1

2-Acryloyloxyethyl isocyanate (AOI) was rectified to remove a polymerization inhibitor to not more than 10 mass ppm. To this 2-acryloyloxyethyl isocyanate, 500 mass ppm of TEMPO based on 2-acryloyloxyethyl isocyanate was added as a polymerization inhibitor to prepare a 2-acryloyloxyethyl isocyanate solution. The concentration of the polymerization inhibitor was confirmed by gas chromatography.

Then, in order to eliminate the influence of molecular oxygen on the preventive effect of polymerization and to examine the effect of TEMPO alone on the prevention of polymerization, 5 ml of the 2-acryloyloxyethyl isocyanate solution was placed in a 20 ml test tube, which was degassed under vacuum for 1 min to remove oxygen dissolved in the 2-acryloyloxyethyl isocyanate solution. Nitrogen was then fed into the tube. These procedures of degassing and nitrogen purging were repeated three times, and the opening of the test tube was sealed with a rubber stopper in which a glass-covered thermocouple was inserted. The thermocouple was immersed in the internal liquid such that the tip of the thermocouple was in the middle of the internal liquid, and the thermocouple was connected to an automatic temperature recorder. The test tube was immersed in an oil bath at 100° C. and the polymerization initiation time of 2-acryloyloxyethyl isocyanate was measured. The polymerization initiation time was defined as the time from the immersion of the test tube in the oil bath to when the liquid in the test tube started to generate heat due to the polymerization. The results are shown in Table 1.

### <Gas Chromatography Conditions>

Column: DB-1 supplied by J&W Scientific Inc. (length 30 m×inner diameter 0.32 mm×coating thickness 1 μm)
Temperature of sample injection chamber: 300° C.
Temperature of detector: 300° C.
Detector: FID (hydrogen flame ionization detector)
Temperature elevation program: from 50 to 320° C. at 10° C./min (held at 320° C. for 5 min)
Flow rate of carrier gas: 1.2 mL/min
Solvent for diluting the sample: methylene chloride

### Examples 1-2 to 1-4

Effect of preventing polymerization was evaluated in the same manner as in Example 1-1, except that the compounds listed in Table 1, each in an amount of 500 mass ppm, were added as a polymerization inhibitor in place of TEMPO to 2-acryloyloxyethyl isocyanate (AOI). The results are shown in Table 1.

### Comparative Examples 1-1 to 1-4

Effect of preventing polymerization was evaluated in the same manner as in Example 1-1, except that the compounds listed in Table 1, each in an amount of 500 mass ppm, were added as a polymerization inhibitor to 2-acryloyloxyethyl isocyanate that had been rectified to remove a polymerization inhibitor to not more than 10 mass ppm. The results are shown in Table 1.

TABLE 1

| | | | | Polymerization |
|---|---|---|---|---|
| | Polymerization | Amount | Temperature | initiation time |
| | inhibitor | added | [° C.] | [hr] |
| Example 1-1 | TEMPO | 500 ppm | 100 | 2838 |
| Example 1-2 | 4-hydroxy- | 500 ppm | 100 | 2554 |
| | TEMPO | | | |
| Example 1-3 | PROXYL | 500 ppm | 100 | 2010 |
| Example 1-4 | DPPH | 500 ppm | 100 | 2589 |
| Comparative | none | — | 100 | 2 |
| Example 1-1 | | | | |
| Comparative | BHT | 500 ppm | 100 | 606 |
| Example 1-2 | | | | |
| Comparative | phenothiazine | 500 ppm | 100 | 64 |
| Example 1-3 | | | | |
| Comparative | hydroquinone | 500 ppm | 100 | 321 |
| Example 1-4 | | | | |

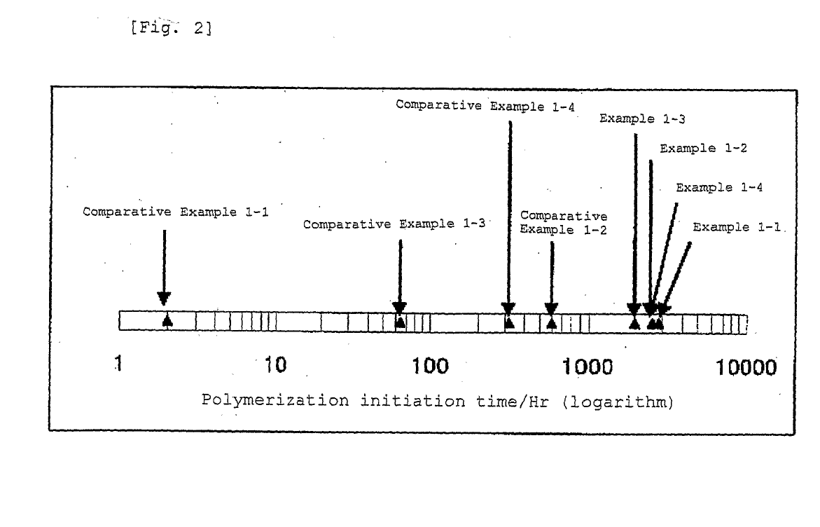

Because the polymerization initiation time is proportional to the reciprocal of the reaction rate, it is preferable to evaluate the polymerization initiation time in logarithms. For example, according to Japanese Industrial Standard JIS-K-6795, the expected life of resins is evaluated based on logarithms of the life time of the resins. In FIG. 2, the results of Table 1 are plotted in the logarithms of the polymerization initiation time. The stable free radical compounds are proved to be highly effective in preventing polymerization.

The results of Examples 1-1 to 1-4 and Comparative Examples 1-1 to 1-4 show that the stable radical compounds can retard the polymerization initiation as compared to other polymerization inhibitors, thus proving high effect of preventing polymerization.

### Examples 2-1 to 2-4

Effect of preventing polymerization was evaluated in the same manner as in Example 1-1, except that 2-acryloyloxyethyl isocyanate was replaced by 2-methacryloyloxyethyl isocyanate (MOI) that had been rectified to remove a polymerization inhibitor to not more than 10 mass ppm. The results are shown in Table 2.

### Comparative Examples 2-1 to 2-4

Effect of preventing polymerization was evaluated in the same manner as in Example 2-1, except that the compounds listed in Table 2, each in an amount of 500 mass ppm, were added as a polymerization inhibitor to 2-methacryloyloxyethyl isocyanate (MOI) that had been rectified to remove a polymerization inhibitor to not more than 10 mass ppm. The results are shown in Table 2.

TABLE 2

| | | | | Polymerization |
|---|---|---|---|---|
| | Polymerization | Amount | Temperature | initiation time |
| | inhibitor | added | [° C.] | [hr] |
| Example 2-1 | TEMPO | 500 ppm | 100 | 3023 |
| Example 2-2 | 4-hydroxy- | 500 ppm | 100 | 2893 |
| | TEMPO | | | |
| Example 2-3 | PROXYL | 500 ppm | 100 | 2112 |
| Example 2-4 | DPPH | 500 ppm | 100 | 2539 |
| Comparative | none | — | 100 | 4 |
| Example 2-1 | | | | |
| Comparative | BHT | 500 ppm | 100 | 740 |
| Example 2-2 | | | | |
| Comparative | phenothiazine | 500 ppm | 100 | 93 |
| Example 2-3 | | | | |
| Comparative | hydroquinone | 500 ppm | 100 | 392 |
| Example 2-4 | | | | |

The results of Examples 2-1 to 2-4 and Comparative Examples 2-1 to 2-4 show that the stable radical compounds can retard the polymerization initiation as compared to other polymerization inhibitors, thus proving high effect of preventing polymerization.

### Examples 3-1 to 3-3

Effects were studied of a combination of the stable radical compounds and other polymerization inhibitors. Effect of preventing polymerization was evaluated in the same manner as in Example 1-1, except that the compounds listed in Table 3, each in an amount of 250 mass ppm, were added as polymerization inhibitors to 2-acryloyloxyethyl isocyanate (AOI). The results are shown in Table 3.

### Comparative Examples 3-1 and 3-2

Effect of preventing polymerization was evaluated in the same manner as in Example 1-1, except that the compounds listed in Table 3, each in an amount of 250 mass ppm, were added as polymerization inhibitors to 2-acryloyloxyethyl isocyanate (AOI). The results are shown in Table 3.

TABLE 3

| | Polymerization | Amount | Polymerization | Amount | Temperature | Polymerization |
|---|---|---|---|---|---|---|
| | inhibitor | added | inhibitor | added | [° C.] | initiation time [hr] |
| Example 3-1 | TEMPO | 250 ppm | 4-hydroxy-TEMPO | 250 ppm | 100 | 2303 |
| Example 3-2 | TEMPO | 250 ppm | hydroquinone | 250 ppm | 100 | 1793 |
| Example 3-3 | PROXYL | 250 ppm | hydroquinone | 250 ppm | 100 | 1825 |
| Comparative | BHT | 250 ppm | hydroquinone | 250 ppm | 100 | 402 |
| Example 3-1 | | | | | | |
| Comparative | BHT | 250 ppm | phenothiazine | 250 ppm | 100 | 911 |
| Example 3-2 | | | | | | |

The results of Examples 3-1 to 3-3 and Comparative Examples 3-1 and 3-2 show that the stable radical compounds in combination with other polymerization inhibitors can retard the polymerization initiation as compared to when other polymerization inhibitors were used alone without the stable radical compounds. These results prove that the stable radical compounds are highly effective in preventing polymerization.

### Example 4-1

To 2-acryloyloxyethyl isocyanate (AOI) that had been rectified to remove a polymerization inhibitor to not more than 10 mass ppm, TEMPO was added as a polymerization inhibitor in an amount of 1 mass % relative to 2-acryloyloxyethyl isocyanate, resulting in a solution. A 200-ml eggplant-shaped flask with a magnetic stirrer was charged with 50 g of this solution. A Dimroth condenser was attached to the flask. Before use, the Dimroth condenser had been heated at 100° C. in an electric oven for 1 hr, cooled, sufficiently dried, and weighed. The eggplant-shaped flask was placed in an oil bath controlled at 80° C., to start heating. The pressure was kept at 4 Torr. This heating test under vacuum was continued for 24 hr, but no polymer adherence was observed on the Dimroth condenser. After the test, the Dimroth condenser was washed with hexane, heated at 100° C. in an electric oven for 1 hr, cooled, sufficiently dried, and weighed. The amount of polymer formed in the vapor phase was estimated from an increase in weight of the condenser attributed to matters attached thereto. The results are shown in Table 4.

### Examples 4-2 to 4-4

Effect of preventing polymerization was evaluated in the same manner as in Example 4-1, except that TEMPO was replaced by the polymerization inhibitors listed in Table 4 which were each used in an amount of 1 mass % relative to 2-acryloyloxyethyl isocyanate (AOI). No polymer was attached to the Dimroth condenser. The results are shown in Table 4.

### Comparative Examples 4-1 to 4-4

Effect of preventing polymerization was evaluated in the same manner as in Example 4-1, except that the compounds listed in Table 4 were added, each in an amount of 1 mass %, to 2-acryloyloxyethyl isocyanate (AOI) that had been rectified to remove a polymerization inhibitor to not more than 10 mass ppm. The results are shown in Table 4.

TABLE 4

| | | | | Weight |
|---|---|---|---|---|
| | Polymerization | Amount | Temperature | increase |
| | inhibitor | added | [° C.] | of condenser |
| Example 4-1 | TEMPO | 1% | 80 | 0.03 g |
| Example 4-2 | 4-hydroxy-TEMPO | 1% | 80 | 0.09 g |
| Example 4-3 | PROXYL | 1% | 80 | 0.05 g |
| Example 4-4 | DPPH | 1% | 80 | 0.21 g |
| Comparative | none | — | 80 | 4.23 g |
| Example 4-1 | | | | |
| Comparative | BHT | 1% | 80 | 1.19 g |
| Example 4-2 | | | | |
| Comparative | phenothiazine | 1% | 80 | 3.28 g |
| Example 4-3 | | | | |
| Comparative | hydroquinone | 1% | 80 | 1.54 g |
| Example 4-4 | | | | |

The results of Examples 4-1 to 4-4 and Comparative Examples 4-1 to 4-4 show that when the stable radical compounds with a vapor pressure approximate to that of 2-acryloyloxyethyl isocyanate (AOI) are used, the increase of condenser weight is small as compared to when other polymerization inhibitors are used. These results prove that the stable radical compounds are highly effective in preventing polymerization of the condensate attached to the condenser.

1. A polymerizable monomer composition comprising a (meth)acryloyl group-containing isocyanate compound and a stable free radical compound.

2. The polymerizable monomer composition according to claim 1, wherein the stable free radical compound is represented by the following general formula (1): 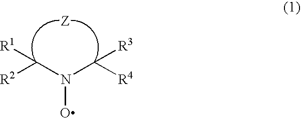
wherein R¹, R², R³, and R⁴ are each independently a hydrogen atom, a linear or branched alkyl group which is substituted or unsubstituted, or a substituted or unsubstituted aryl group, at least one of R¹ and R² is a linear or branched alkyl group which is substituted or unsubstituted, or a substituted or unsubstituted aryl group, and at least one of R³ and R⁴ is a linear or branched alkyl group which is substituted or unsubstituted, or a substituted or unsubstituted aryl group;
R¹ and R² may be bonded to each other to form a cyclic structure;
R³ and R⁴ may be bonded to each other to form a cyclic structure; and
Z is an alkylene group having 2 to 5 carbon atoms or a bivalent aromatic group, wherein the alkylene group or the aromatic group may further have a substituent.

3. The polymerizable monomer composition according to claim 2, wherein Z is a substituted or unsubstituted alkylene group having 2 or 3 carbon atoms.

4. The polymerizable monomer composition according to claim 1, wherein the stable free radical compound is at least one compound selected from 2,2,6,6-tetramethylpiperidine-N-oxyl and 4-hydroxy-2,2-6,6-tetramethylpiperidine-N-oxyl.

5. The polymerizable monomer composition according to claim 1, wherein the stable free radical compound is contained in an amount of 1 mass ppm to 10 mass % relative to the (meth)acryloyl group-containing isocyanate compound.

6. The polymerizable monomer composition according to claim 1, wherein the (meth)acryloyl group-containing isocyanate compound is at least one compound selected from 2-methacryloyloxyethyl isocyanate, 4-methacryloyloxybutyl isocyanate, 5-methacryloyloxypentyl isocyanate, 6-methacryloyloxyhexyl isocyanate, 2-acryloyloxyethyl isocyanate, 3-methacryloyloxyphenyl isocyanate, and 1,1-bis(acryloyloxymethyl)ethyl isocyanate.

7. A method for preventing polymerization of a (meth)acryloyl group-containing isocyanate compound, wherein a stable free radical compound is used as a polymerization inhibitor for the (meth)acryloyl group-containing isocyanate compound.

8. The method for preventing polymerization of a (meth)acryloyl group-containing isocyanate compound according to claim 7, wherein the stable free radical compound is represented by the following general formula (1): 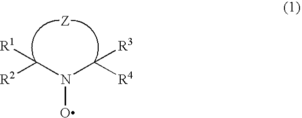
wherein R¹, R², R³, and R⁴ are each independently a hydrogen atom, a linear or branched alkyl group which is substituted or unsubstituted, or a substituted or unsubstituted aryl group, at least one of R¹ and R² is a linear or branched alkyl group which is substituted or unsubstituted, or a substituted or unsubstituted aryl group, and at least one of R³ and R⁴ is a linear or branched alkyl group which is substituted or unsubstituted, or a substituted or unsubstituted aryl group;
R¹ and R² may be bonded to each other to form a cyclic structure;
R³ and R⁴ may be bonded to each other to form a cyclic structure; and
Z is an alkylene group having 2 to 5 carbon atoms or a bivalent aromatic group, wherein the alkyene group or the aromatic group may further have a substituent.

9. The method for preventing polymerization of a (meth)acryloyl group-containing isocyanate compound according to claim 8, wherein Z is a substituted or unsubstituted alkylene group having 2 or 3 carbon atoms.

10. The method for preventing polymerization of a (meth)acryloyl group-containing isocyanate compound according to claim 7, wherein a vapor pressure of the stable free radical compound is 0.2 to 5 times that of the (meth)acryloyl group-containing isocyanate compound.

11. The method for preventing polymerization of a (meth)acryloyl group-containing isocyanate compound according to claim 7, wherein the stable free radical compound is at least one compound selected from 2,2,6,6-tetramethylpiperidine-N-oxyl and 4-hydroxy-2,2,6,6-tetramethylpiperidine-N-oxyl.

12. The method for preventing polymerization of a (meth)acryloyl group-containing isocyanate compound according to claim 7, wherein the stable free radical compound is used in an amount of 1 mass ppm to 10 mass % relative to the (meth)acryloyl group-containing isocyanate compound.

13. The method for preventing polymerization of a (meth)acryloyl group-containing isocyanate compound according to claim 7, wherein the (meth)acryloyl group-containing isocyanate compound is at least one compound selected from 2-methacryloyloxyethyl isocyanate, 4-methacryloyloxybutyl isocyanate, 5-methacryloyloxypentyl isocyanate, 6-methacryloyloxyhexyl isocyanate, 2-acryloyloxyethyl isocyanate, 3-methacryloyloxyphenyl isocyanate, and 1,1-bis(acryloyloxymethyl)ethyl isocyanate.

14. The method for preventing polymerization of a (meth)acryloyl group-containing isocyanate compound according to claim 7, wherein at least one selected from phenolic polymerization inhibitors, sulfur polymerization inhibitors, and phosphorus polymerization inhibitors is used together as a polymerization inhibitor.

15. A polymer composition comprising a (co)polymer with structural units derived from a (meth)acryloyl group-containing isocyanate compound, and a stable free radical compound.

16. A method for manufacturing a polymer composition, comprising polymerizing the polymerizable monomer composition according to claim 1.
